(19) United States
(12) Patent Application Publication
(10) Pub. No.: US 2020/0333145 A1
(43) Pub. Date: Oct. 22, 2020

(54) SERVER DEVICE, ONBOARD APPARATUS, AND DATA COMMUNICATION METHOD

(71) Applicant: Clarion Co., Ltd., Saitama-shi, Saitama (JP)

(72) Inventor: Katsuya ASADA, Ebina-shi (JP)

(73) Assignee: Clarion Co., Ltd., Saitama-shi, Saitama (JP)

(21) Appl. No.: 16/765,414

(22) PCT Filed: Sep. 12, 2018
(86) PCT No.: PCT/JP2018/033803

§ 371 Date: May 19, 2020

(30) Foreign Application Priority Data
Nov. 24, 2017 (JP) 2017-225478

(51) Int. Cl. G01C 21/32; G06F 8/65; G06F 8/61; H04W 4/48

(52) U.S. Cl. CPC G01C 21/32; H04W 4/48; G06F 8/64; G06F 8/65

(57) ABSTRACT

An object of the present invention is to acquire data smoothly even when an amount of data to be acquired is large. A server device according to the present embodiment includes: a storage unit configured to store predetermined information to be provided to an external device; a segment data generation unit configured to receive information for specifying a remaining storable capacity of the external device via communication from the external device and generate a plurality of data sets obtained by dividing the predetermined information substantially evenly in a size depending on the remaining storable capacity; and a data transmission control unit configured to transmit, to the external device, the plurality of data sets by a number corresponding to the remaining storable capacity.

### TECHNICAL FIELD

The present invention relates to a technique of a server device, an onboard device, and a data communication method. The present invention claims priority to Japanese Patent Application No. 2017-225478, filed on Nov. 24, 2017, the contents of which are incorporated by reference herein in its entirety in designated states where the incorporation of documents by reference is approved.

### BACKGROUND ART

PTL 1 describes a technique relating to “a method of updating a car navigation map for a car navigation device, comprising the steps of establishing connection with a mobile terminal, transmitting a profile to the mobile terminal via the connection that is established, the profile containing regional information to which map data in a navigation map belongs and version information of map data corresponding to the regional information, receiving, from the mobile terminal, the latest map data acquired by the mobile terminal based on the profile, and updating map data relating to a corresponding region being a region to which the latest map data of the car navigation device belongs”.

### CITATION LIST

### Patent Literature

PTL 1: JP 2016-105080 A

### SUMMARY OF INVENTION

### Technical Problem

In the technique described above, the communication between the mobile terminal and the server enables updating the map data relating to the corresponding region of the car navigation device. However, when an amount of the map data is large, the communication requires a long time period, which may cause the update to require a long time period in some cases.

An object of the present invention is to provide a server device, an onboard device, and a data communication unit, which are capable of acquiring data smoothly even when an amount of data to be acquired is large.

### Solution to Problem

The present invention includes a plurality of solutions to at least a part of the problem described above. One example of the solutions is as follows. In order to solve the above-mentioned problem, a server device according to the present invention includes: a storage unit configured to store predetermined information to be provided to an external device; a segment data generation unit configured to receive information for specifying a remaining storable capacity of the external device via communication from the external device and generate a plurality of data sets obtained by dividing the predetermined information substantially evenly in a size depending on the remaining storable capacity; and a data transmission control unit configured to transmit, to the external device, the plurality of data sets by a number corresponding to the remaining storable capacity.

### Advantageous Effects of Invention

According to the invention of the present application, even when an amount of data to be acquired is large, the data can be acquired smoothly. A problem, configuration, and effect other than those described above will be apparent from the description of embodiments given below.

### BRIEF DESCRIPTION OF DRAWINGS

FIG. 1 is a diagram illustrating a configuration of a data communication system to which an embodiment of the present invention is applied.

FIG. 2 is a diagram illustrating an example of a hardware configuration of an onboard device.

FIG. 3 is a diagram illustrating an example of a hardware configuration of a smartphone.

FIG. 4 is a diagram illustrating an example of a hardware configuration of a server device.

FIG. 5 is a diagram illustrating a flow of preceding relay processing and preceding server processing.

FIG. 6 is a diagram illustrating a flow of segment information acquisition processing and smartphone processing.

FIG. 7 is a diagram illustrating an example of movement of data.

### DESCRIPTION OF EMBODIMENTS

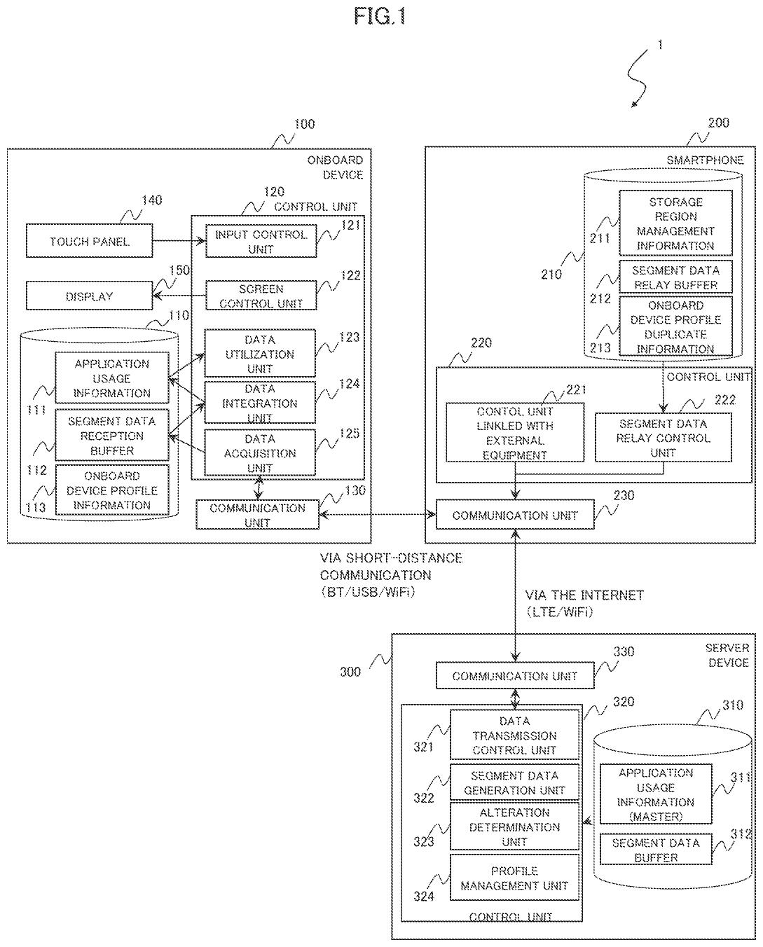

With reference to the drawings, description is given below on a data communication system including a server device according to the present invention. Note that FIG. 1 to FIG. 7 are not intended to illustrate all the configurations of a data communication system 1, and illustration is given by partially omitting the configurations as appropriate for easy understanding. Note that, in all the drawings for describing the embodiment, in principle, the identical members are denoted with the identical reference signs, and repeated description therefor is omitted in some cases. Further, in the following embodiment, it goes without saying that constituent elements therein (including element steps and the like) are not necessarily essential unless otherwise particularly stated or incontrovertibly considered as essentials in principle. Further, when the expressions “constituted of A”, “being formed of A”, “including A”, and “comprising A” are given, it goes without saying that the expressions are not intended to exclude elements other than A unless A otherwise is clearly stated as the only element. Similarly, in the following embodiment, when shapes, positional relationships, and the like of the constituent elements and the like are referred to, substantially approximate or similar shapes and the like are included unless otherwise particularly stated or incontrovertibly considered to be different in principle or the like.

FIG. 1 illustrates a configuration of a data communication system to which the embodiment of the present invention is applied. In the data communication system 1 to which the embodiment of the present invention is applied, control performed by application software is included as part of control for an onboard device 100, a smartphone 200, and a server device 300. In the onboard device 100, it is assumed that a function of application that performs navigation is achieved by application software operated under management of an operating system (OS) or the like of the onboard device 100. Meanwhile, in the server device 300, it is assumed that a navigation device-related function such as a point-of-interest (POI) search application and a destination setting function and an additional function such as a data distribution function are achieved by application software operated under management of an operating system (OS) or the like of the server device 300.

The onboard device 100 is an information processing device capable of executing various types of software, and is specifically a navigation device. In the present embodiment, the onboard device 100 includes an OS, is capable of using contents such as a plurality pieces of software, and is also capable of executing contents such as application software in parallel. The onboard device 100 is not limited to a dedicated device that is used in an onboard state, and may be various types of independently operable devices such as a personal computer, a smartphone, and a tablet terminal. Note that, not only in the present embodiment but also in all the embodiments, the application software benefits a user on one matter regardless of presence or absence of screen display and presence or absence of voice or sound output, and includes processing relating to software management, static images, moving images, photographs, voice or sound, and the like.

The onboard device 100 includes a storage unit 110, a control unit 120, a communication unit 130, a touch panel 140, and a display 150. The storage unit 110 includes an application usage information 111, a segment data reception buffer 112, and an onboard device profile information 113. The control unit 120 includes processing units serving as an input control unit 121, a screen control unit 122, a data utilization unit 123, a data integration unit 124, and a data acquisition unit 125.

The application usage information 111 is information utilized by the data utilization unit 123 for processing. The application usage information 111 includes map data, graphic data for screen display, and sound data for voice or sound output, for example.

The segment data reception buffer 112 is segment data sets received by the data acquisition unit 125.

The onboard device profile information 113 is information indicating a version or the like of the onboard device, including a model and a unique number of the onboard device 100, mainly indicates model specification information on the onboard device 100. In addition to this, information indicating a specification of hardware of the onboard device 100 (for example, a drawing range of the screen, graphic display performance, operation speed, available memory, and communication speed) may be included.

The input control unit 121 receives input from the touch panel 140 or a hardware key (not illustrated). The screen control unit 122 controls screen display of the display 150. The data utilization unit 123 executes various types of processing through use of the application usage information 111 that is acquired by the data integration unit 124 through integration. The data utilization unit 123 is, for example, a navigation processing unit that outputs navigation screen through use of the application usage information 111 being map data.

The data integration unit 124 integrates segment data sets acquired by the data acquisition unit 125, and generates original data before division. Specifically, the data sets stored in the segment data reception buffer 112 are integrated by integration processing, to generate the application usage information 111.

The data acquisition unit 125 receives the segment data sets from the smartphone 200 serving as a relay device in the communication with the server device 300, and stores the data sets in the segment data reception buffer 112. The data acquisition unit 125 transmits the onboard device profile information 113 to the smartphone 200, and requests the segment data sets.

The communication unit 130 performs communication with the smartphone 200. The communication method utilizes short-distance communication via Bluetooth (registered trademark), Universal Serial Bus (USB) (registered trademark), WiFi (registered trademark), or the like, but is not limited thereto. The communication unit 130 may be connected to the Internet or the like via the smartphone 200. The touch panel 140 is capable of specifying a position of touch input on the panel through use of an electrostatic type or a pressure-sensitive type sensor. The display 150 is a display device such as organic electro luminescence (EL) and liquid crystal. By incorporating the touch panel 140 on the display 150, touch input on a display object on the display screen can be detected.

The smartphone 200 is an information processing device capable of performing communication via a wireless telephone network or a wireless data communication network. Normally, the smartphone 200 is provided with an operating system (OS) of a predetermined version, and application software of a predetermined version is executed. The smartphone 200 includes a storage unit 210, a control unit 220, and a communication unit 230.

The storage unit 210 includes a storage region management information 211, a segment data relay buffer 212, and an onboard device profile duplicate information 213. The storage region management information 211 includes management information relating to a storage region that can be managed by the smartphone 200. Such management information includes information specifying a usage state such as an occupancy ratio of each data type and a remaining storable capacity in the storage region.

The segment data relay buffer 212 is a buffer that temporarily stores the segment data sets acquired from the server device 300 until the data sets are transferred to the onboard device 100.

The onboard device profile duplicate information 213 is a duplicate of the onboard device profile information 113 acquired from the onboard device 100. Note that the smartphone 200 can be connected to a different onboard device 100, and hence the onboard device profile duplicate information 213 can be regarded as a duplicate of the onboard device profile information 113 of a most-recently-connected onboard device 100.

The control unit 220 includes processing units serving as a control unit 221 linked with external equipment and the segment data relay control unit 222. The control unit 221 linked with external equipment controls inter-connected operation with an external device. Specifically, the control unit 221 linked with external equipment controls processing related to a coordinated action with the onboard device 100, sharing of music data, a relay of communication, sharing of calendar information, and the like. The control unit 221 linked with external equipment acquires the onboard device profile information 113 from the onboard device 100 being an external device, and stores the information as the onboard device profile duplicate information 213 in the storage unit 210.

The segment data relay control unit 222 controls a relay of data transmitted from the server device 300 to the onboard device 100. Specifically, when information used by application software includes segment data sets, the segment data relay control unit 222 controls an acquisition amount of the segment data sets in consideration of the remaining storable capacity of the smartphone 200, and performs a relay to achieve efficient communication.

For example, under a state in which the remaining storable capacity of the smartphone 200 is 200 MB (megabyte), when the onboard device 100 acquires map data of 300 MB from the server device 300, it is not possible to store all the map data of 300 MB acquired from the server device 300 in the storage unit 210 due to lack in remaining storable capacity. In such case, the segment data relay control unit 222 precedently acquires a part of map data, two segment map data sets each in a unit of 100 MB (total 200 MB) in the segment data relay buffer 212. After connection with the onboard device 100 is established, one segment map data set (that is, a data set of 100 MB), which is precedently acquired in the segment data relay buffer 212, is transmitted to the onboard device 100. After the transmission is performed normally, the transmitted data is deleted, and the remaining storable capacity is increased by 100 MB. Then, one segment map data set (that is, a data set of 100 MB), which is not yet acquired, is acquired from the server device 300 through the Internet.

In parallel to this, the segment data relay control unit 222 transmits the second segment map data set (that is, a data set of 100 MB) to the onboard device 100 via the short-distance communication. With this, as compared to a case where data acquisition from the server device 300 is started at the time point when the onboard device 100 and the smartphone 200 are connected, the map data can be used earlier.

The communication unit 230 performs communication with the onboard device 100. The communication method utilizes short-distance communication such as Bluetooth (registered trademark), USB (registered trademark), or WiFi (registered trademark), but is not limited thereto. The communication unit 230 performs communication with another device connected to the Internet. The communication method is on the Internet via LTE (registered trademark), WiFi (registered trademark), or the like, but is not limited thereto.

The server device 300 is connected to be communicable with the smartphone 200 via a network such as the Internet. The server device 300 is a so-called computer server device, and includes a storage unit 310, a control unit 320, and a communication unit 330.

Application usage information (master) 311 and segment data buffer 312 are stored in the storage unit 310. The control unit 320 includes a data transmission control unit 321, a segment data generation unit 322, an alteration determination unit 323, and a profile management unit 324.

The application usage information (master) 311 is information utilized by the data utilization unit 123 of the onboard device 100 for processing. The application usage information (master) 311 includes data such as map data, graphic data for screen display, and sound data for voice or sound output, which are used in the onboard device 100 being an external device in addition to the smartphone 200.

The segment data buffer 312 stores data sets obtained by dividing the application usage information (master) 311 in a substantially even size for each smartphone 200. Note that it is desired that the size of the data set be a half of the remaining storable capacity of the smartphone 200 or smaller, for example.

The data transmission control unit 321 transmits the data sets obtained by dividing the application usage information (master) 311, which are stored in the segment data buffer 312, to the smartphone 200 by a number corresponding to the remaining storable capacity of the smartphone 200 being an external device. For example, when the remaining storable capacity of the smartphone 200 is 200 MB, the data transmission control unit 321 transmits data sets having a data amount of 200 MB (when one data set is 100 MB, transmits two data sets) so that the remaining storable capacity of the smartphone 200 is zero or more.

The segment data generation unit 322 receives the information for specifying the remaining storable capacity of the smartphone 200 being an external device, and generates a plurality of data sets obtained by dividing the application usage information (master) 311 substantially evenly in a size corresponding to the remaining storable capacity. For example, when receiving information indicating that the remaining storable capacity of the smartphone 200 is 200 MB, the segment data generation unit 322 divides the application usage information (master) 311 of 300 MB evenly in a size of 100 MB being a half of the remaining storable capacity of 200 MB or less. Further, the segment data sets are stored in the segment data buffer 312.

When receiving hash information for detecting alteration of the data sets received from the onboard device 100 in the smartphone 200 being an external device via communication from the smartphone 200, the alteration determination unit 323 compares hash information of the corresponding data sets, and determines presence or absence of alteration. Further, presence or absence of alteration is transmitted to the onboard device 100.

The profile management unit 324 manages association between a profile of the onboard device and the application usage information (master) 311. That is, the profile of the onboard device includes information on a model of the onboard device and the like. For example, also with regard to the map data, in a case of a different model, another master is used in some cases. Thus, processing for association is performed in order to assign map data corresponding to the model.

The communication unit 330 performs communication with the smartphone 200. The communication unit 330 performs communication with another device connected to the Internet.

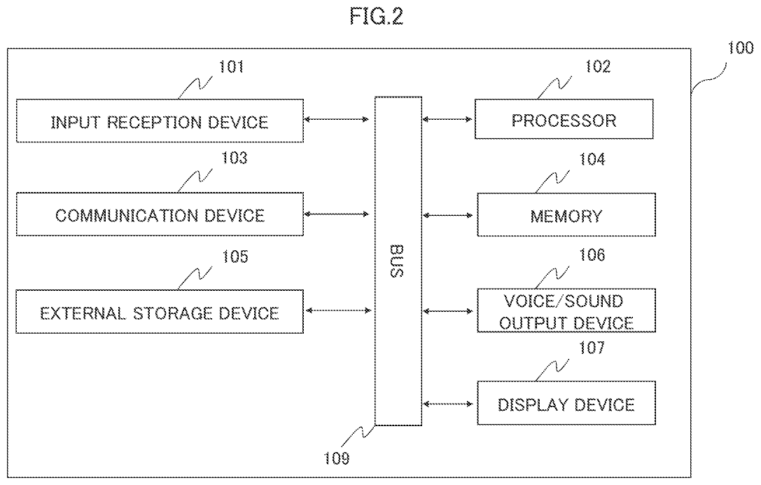

FIG. 2 is a diagram illustrating an example of a hardware configuration of the onboard device 100. The onboard device 100 includes an input reception device 101, an processor 102, a communication device 103, a memory 104, an external storage device 105, a voice/sound output device 106, a display device 107, and a bus 109 that connects those devices.

The input reception device 101 is an input device of various types such as hardware buttons and a touch panel. The processor 102 is an arithmetic device such as a central processing unit (CPU).

The communication device 103 is a device such as a communication module that establishes a communication path with other devices, and transmits and receives information via a short-distance communication or the like.

The memory 104 is a memory device such as a random access memory (RAM).

The external storage device 105 is a device that writes information in a non-volatile storage medium such as a hard disc, a solid state drive (SSD), and other types, or reads out predetermined information from a non-volatile storage medium.

The voice/sound output device 106 is a so-called speaker that receives voice/sound information, converts the information to voice or sound, and outputs the voice or sound.

The display device 107 is a device that performs display output, such as liquid crystal display and an electro luminescence (EL) display.

The function units of the control unit 120 described above, specifically, the input control unit 121, the screen control unit 122, the data utilization unit 123, the data integration unit 124, and the data acquisition unit 125 are achieved by the processor 102 reading and executing predetermined programs. Thus, in the memory 104, the programs for achieving the processing of the function units are stored.

The storage unit 110 described above is implemented by the memory 104 or the external storage device 105, the touch panel 140 is implemented by the input reception device 101, and the display 150 is implemented by the display device 107, respectively.

Note that the constituent elements described above are illustrated by classifying the configuration of the onboard device 100 in accordance with main processing contents for easy understanding. Thus, how the constituent elements are classified and referred to do not limit the invention of the present application. The configuration of the onboard device 100 can be classified into more constituent elements in accordance with contents of processing. Classification can be performed so that one constituent element executes more processing.

Each processing unit of the control unit 120 is not limited to a CPU, and may be configured by hardware (ASIC, a graphics processing unit (GPU), or the like). Processing of each function unit may be executed by one piece of hardware, or may be executed by a plurality of pieces of hardware.

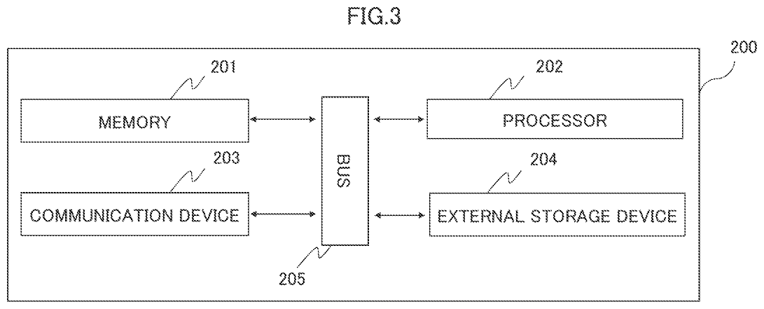

FIG. 3 is a diagram illustrating an example of a hardware configuration of the smartphone 200. The smartphone 200 includes a memory 201, an processor 202, a communication device 203, an external storage device 204, and a bus 205 that connects those devices.

The memory 201 is a memory device such as a RAM.

The processor 202 is an arithmetic device such as a CPU. The communication device 203 is a device such as a network module that establishes a communication path with a mobile phone base station or the onboard device 100 being another device, and transmits and receives information, via a mobile phone network, the short-distance communication, or the like.

The external storage device 204 is a device that writes information in a non-volatile storage medium such as an SSD, and other types, or reads out predetermined information from a non-volatile storage medium.

The processing units of the control unit 220 described above, specifically, the control unit 221 linked with external equipment and the segment data relay control unit 222 are achieved by the processor 202 reading and executing predetermined programs. Thus, in the memory 201, the programs for achieving the processing of the function units are stored.

The storage unit 210 described above is implemented by the memory 201 or the external storage device 204.

Note that Note that the constituent elements described above are illustrated by classifying the configuration of the smartphone 200 in accordance with main processing contents for easy understanding. Thus, how the constituent elements are classified and referred to do not limit the invention of the present application. The configuration of the smartphone 200 can be classified into more constituent elements in accordance with contents of processing. Classification can be performed so that one constituent element executes more processing.

Each function unit of the control unit 220 is not limited to a CPU, and may be configured by hardware such as a GPU. Processing of each function unit may be executed by one piece of hardware, or may be executed by a plurality of pieces of hardware.

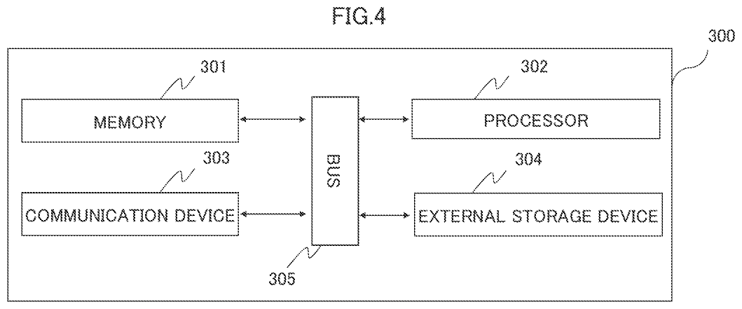

FIG. 4 is a diagram illustrating an example of a hardware configuration of the server device 300. The server device 300 includes a memory 301, an processor 302, a communication device 303, an external storage device 304, and a bus 305 that connects those devices.

The memory 301 is a memory device such as a RAM.

The processor 302 is an arithmetic device such as a CPU. The communication device 303 is a device such as a network module that establishes a communication path with an external device, i.e., the smartphone 200 or the onboard device 100 via the smartphone 200, and transmits and receives information, via a network or the like.

The external storage device 304 is a device that writes information in a non-volatile storage medium such as a hard disc, an SSD, and other types, or reads out predetermined information from a non-volatile storage medium.

The function units of the control unit 320 described above, specifically, the data transmission control unit 321, the segment data generation unit 322, the alteration determination unit 323, and the profile management unit 324 are achieved by the processor 302 reading and executing predetermined programs. Thus, in the memory 301, the programs for achieving the processing of the function units are stored.

The storage unit 310 described above is implemented by the memory 301 or the external storage device 304.

Note that the constituent elements described above are illustrated by classifying the configuration of the server device 300 in accordance with main processing contents for easy understanding. Thus, how the constituent elements are classified and referred to do not limit the invention of the present application. The configuration of the server device 300 can be classified into more constituent elements in accordance with contents of processing. Classification can be performed so that one constituent element executes more processing.

Each processing unit of the control unit 320 is not limited to a CPU, and may be configured by hardware such as a GPU. Processing of each function unit may be executed by one piece of hardware, or may be executed by a plurality of pieces of hardware.

[Description of Operation]

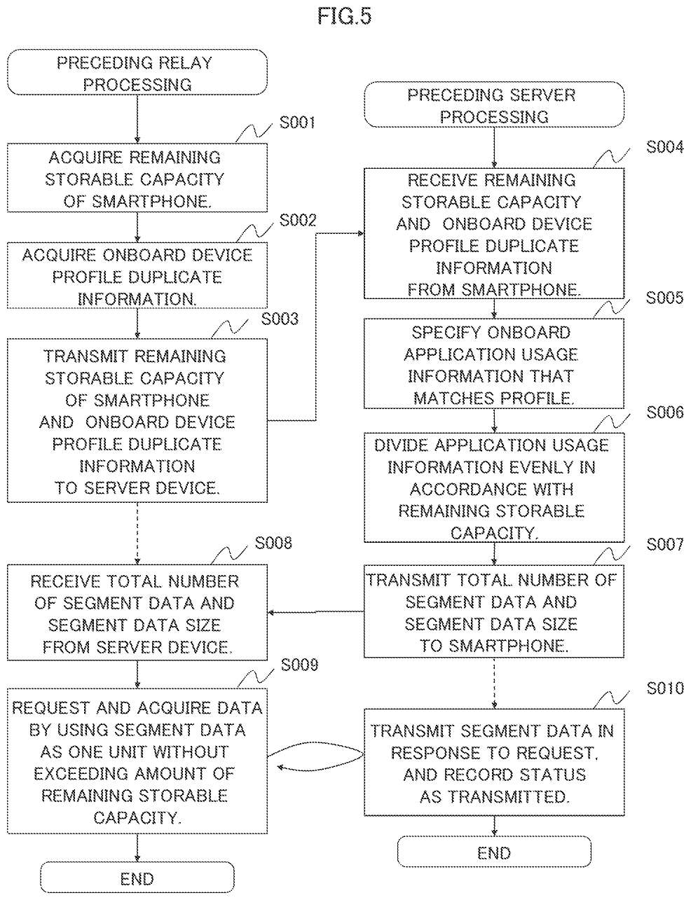

Next, description is given on an operation in a flow of preceding relay processing relating to data communication. FIG. 5 is a diagram illustrating a flow of preceding relay processing and preceding server processing. The preceding relay processing is started with the smartphone 200 when the smartphone 200 receives a request therefor.

First, the segment data relay control unit 222 acquires the remaining storable capacity of the smartphone 200 (Step S001). Specifically, the segment data relay control unit 222 reads the remaining storable capacity of the smartphone 200 from the storage region management information 211.

Further, the segment data relay control unit 222 acquires the onboard device profile information (Step S002). Specifically, the segment data relay control unit 222 reads the onboard device profile duplicate information 213.

Further, the segment data relay control unit 222 transmits the smartphone remaining storable capacity and the onboard device profile duplicate information to the server device 300 (Step S003).

Further, the data transmission control unit 321 receives the remaining storable capacity and the onboard device profile duplicate information from the smartphone 200 (Step S004).

Further, the profile management unit 324 specifies the application usage information on the onboard device that matches the profile (Step S005). Specifically, the profile management unit 324 specifies the application usage information (master) 311 that corresponds to the received onboard device profile duplicate information.

Then, the segment data generation unit 322 divides the specified application usage information (master) 311 evenly in accordance with the remaining storable capacity, and stores the information in the segment data buffer 312 (Step S006). Specifically, the segment data generation unit 322 sets a size of the segment data sets to be a size that satisfies a half of the remaining storable capacity or less and a maximum size in which the application usage information (master) 311 can be divided evenly into three or more, divides the specified application usage information (master) 311 evenly in the set size, and stores the information thus divided in the segment data buffer 312.

Note that the remaining storable capacity is excessively small (for example, 10 MB or less), an effect of the preceding relay processing is not sufficiently exerted, and hence the segment data generation unit 322 may terminate the processing without executing division. When the remaining storable capacity is sufficiently larger than the size of the specified application usage information (master) 311, the segment data generation unit 322 may deal with the application usage information (master) 311 as segment data sets without executing division, and may store the information in the segment data buffer 312. When the size of the application usage information (master) 311 is less than twice of the remaining storable capacity, the segment data generation unit 322 may divide the application usage information (master) 311 evenly into two, and may store the information in the buffer.

Further, the data transmission control unit 321 transmits the total number of segment data and the segment data size to the smartphone 200 (Step S007). Here, the total number of segment data is a total number of data sets obtained as a result of division in Step S006, and the segment data size is a size of the segment data sets that is set in Step S006.

Further, the segment data relay control unit 222 receives the total number of segment data and the segment data size from the server device 300 (Step S008).

Further, the segment data relay control unit 222 requests and acquires data by using the segment data as one unit without exceeding an amount of the remaining storable capacity (Step S009). Specifically, the segment data relay control unit 222 requests and acquires the segment data sets from the server device 300 by a number being a quotient (integer) obtained by dividing the remaining storable capacity by the segment data size.

The data transmission control unit 321 transmits the segment data in response to the request, and records the status as transmitted, for the transmitted segment data (Step S010).

The flow of the preceding relay processing and the preceding server processing is as described above. With the preceding relay processing and the preceding server processing, the smartphone 200 can precedently acquire, from the server device 300, the application usage information by an amount that can be stored in the storage region. Thus, even when the application usage information exceeds the remaining storable capacity, the data can be acquired in advance under a state in which the onboard device 100 is not connected, for example, outside a vehicle before departure, and hence an amount of the data to be acquired after connection with the onboard device 100 can be reduced as much as possible. In other words, even when an amount of data to be acquired is large, the data can be acquired smoothly.

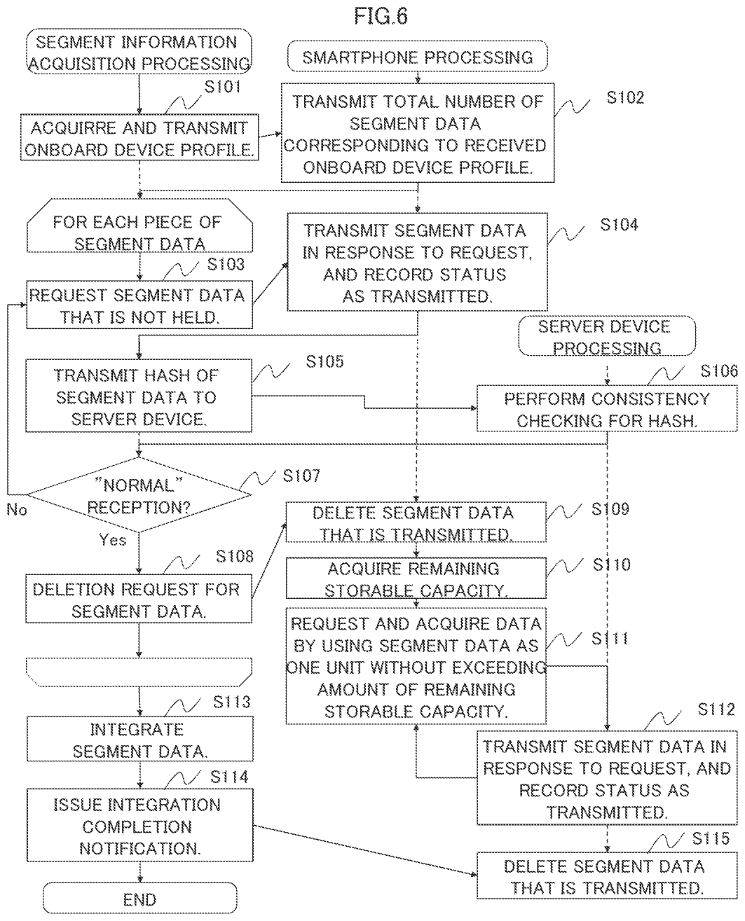

FIG. 6 is a diagram illustrating a flow of segment information acquisition processing and smartphone processing. The segment information acquisition processing is started with the onboard device 100 when the onboard device 100 detects that communication with the smartphone 200 is started.

First, the data acquisition unit 125 acquires and transmits the onboard device profile (Step S101). Specifically, the data acquisition unit 125 acquires the onboard device profile information 113 from the storage unit 110, and transmits the information to the smartphone 200.

Further, the segment data relay control unit 222 of the smartphone 200 transmits the total number of segment data corresponding to the received onboard device profile (Step S102). Specifically, when the received onboard device profile is identical to the onboard device profile duplicate information 213, the segment data relay control unit 222 transmits the total number of segment data, which is received in Step S008 during the preceding relay processing, to the onboard device 100. When the received onboard device profile is not identical to the onboard device profile duplicate information 213, the segment data relay control unit 222 executes the preceding relay processing from Step S001 to Step S008 again, and transmits the total number of received segment data to the onboard device 100.

Further, the data acquisition unit 125 executes processing in Step S103 to Step S108 described later for each piece of the segment data. In other words, the processing in Step S103 to Step S108 described later is executed to one of the segment data sets, and thus the processing is executed repeatedly by the number of the segment data sets.

The data acquisition unit 125 requests segment data that is not held from the smartphone 200 (Step S103). For example, the data acquisition unit 125 requests segment data, which is subsequent to the held segment data, from the smartphone 200.

The segment data relay control unit 222 transmits the segment data sets in response to the request, and records the status as transmitted, for the transmitted segment data sets (Step S104).

Further, the data acquisition unit 125 transmits a hash of the segment data sets to the server device 300 (Step S105). Specifically, the data acquisition unit 125 calculates a hash value of the received segment data sets by a predetermined method. Further, identification information on the segment data sets and the hash value thereof are transmitted to the server device 300 via the smartphone 200.

The alteration determination unit 323 of the server device 300 performs consistency checking for the hash (Step S106). Specifically, the alteration determination unit 323 specifies the segment data sets in the segment data buffer 312, which are already transmitted, from the identification information on the segment data sets, and obtains a hash value of the segment data sets by the same method as the predetermined method applied by the onboard device 100. Further, the alteration determination unit 323 performs comparison with the received hash value, and determines normality or abnormality based on whether or not the comparison result indicates identical. When it is determined as normal, in other words, when the hash value matches, the alteration determination unit 323 transmits a determination result of “normal” to the onboard device 100 via the smartphone 200. When the hash values do not match, the alteration determination unit 323 transmits a determination result of “abnormal” to the onboard device 100 via the smartphone 200.

The data acquisition unit 125 determines whether a determination result of “normal” is received (Step S107). When the determination result of “normal” is not received (“No” in Step S107), the data acquisition unit 125 returns its control to Step S103. In this case, the data acquisition unit 125 specifies the segment data that fails to obtain the determination result of “normal”, and requests data.

When the determination result of “normal” is received (“Yes” in Step S107), the data acquisition unit 125 transmits, to the smartphone 200, a request of deleting the segment data sets that obtain the determination result of “normal” (Step S108).

The segment data relay control unit 222 deletes the transmitted segment data sets being a subject of the deletion request (Step S109). Specifically, among the transmitted segment data sets stored in the segment data relay buffer 212, the segment data relay control unit 222 deletes the transmitted segment data sets being a subject of the deletion request.

Further, the segment data relay control unit 222 acquires the remaining storable capacity of the smartphone 200 (Step S110). Specifically, the segment data relay control unit 222 reads the remaining storable capacity of the smartphone 200 from the storage region management information 211. The segment data sets are deleted in Step S109, and hence this is processing for grasping the remaining storable capacity again.

Further, the segment data relay control unit 222 requests and acquires data by using the segment data as one unit without exceeding an amount of the remaining storable capacity (Step S111). Specifically, the segment data relay control unit 222 requests and acquires the segment data sets from the server device 300 by a number being a quotient (integer) obtained by dividing the remaining storable capacity by the segment data size.

The data transmission control unit 321 transmits the segment data in response to the request, and records the status as transmitted, for the transmitted segment data (Step S112).

Meanwhile, in the onboard device 100 that acquires the segment data, the data integration unit 124 integrates the segment data (Step S113). Specifically, the data integration unit 124 integrates the acquired segment data sets by a predetermined method, and obtains the application usage information before division.

Further, the data integration unit 124 transmits an integration completion notification to the server device 300 (Step S114).

The data transmission control unit 321 deletes the transmitted segment data sets being a subject of the integration completion notification (Step S115). Specifically, among the transmitted segment data sets stored in the segment data relay buffer 212, the data transmission control unit 321 deletes the transmitted segment data sets being a subject of the integration completion notification.

The flow of the segment information acquisition processing and the smartphone processing is as described above. With the segment information acquisition processing and the smartphone processing, the onboard device 100 can acquire the segment data, which is held by held by the preceding relay processing, at high speed from the smartphone 200, and the smartphone 200 can acquire segment data, which is not yet acquired, from the server device 300 in parallel to the processing for relaying the segment data to the onboard device 100.

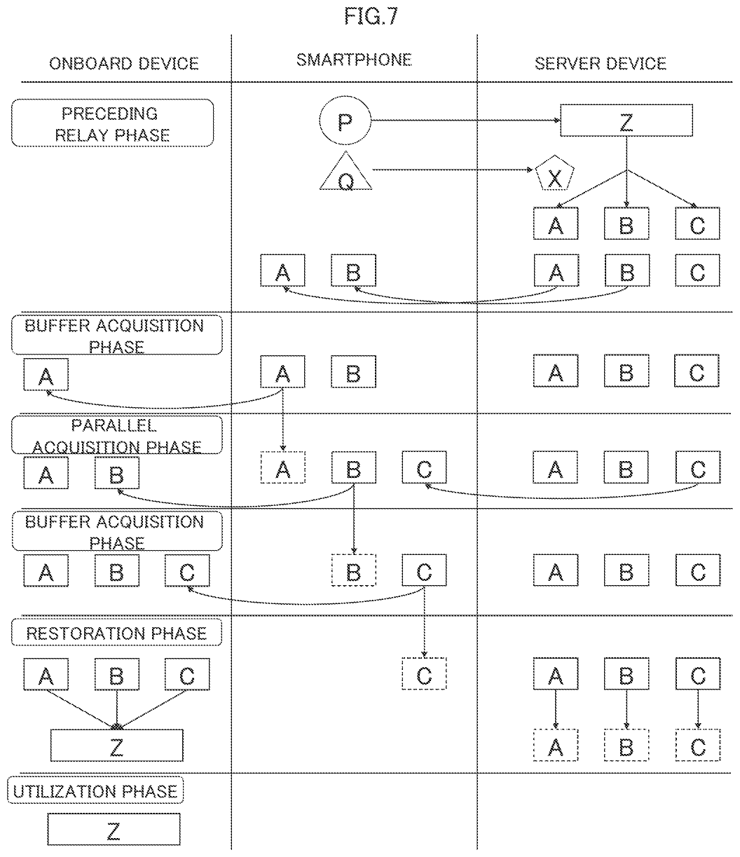

FIG. 7 is a diagram illustrating an example of movement of data. Here, elapse of time is indicated from an upper part of the drawing to a lower part of the drawing, and the storage region of the onboard device 100, the storage region of the smartphone 200, and the storage region of the server device 300 are schematically illustrated in the left, the center, and the right of the drawing, respectively. Data sets (certain blocks of data such as files) are indicated by figures such as rectangles, and arrows indicate data transition. When the data is deleted, a frame of the data set is indicated with a dotted line, and after that, the figure therefor is removed from the drawing.

First, description is given on a preceding relay phase in which the preceding relay processing and the preceding server processing are executed. Data P indicates the onboard device profile duplicate information 213, and moves from the smartphone 200 to the server device 300. With this, in the server device, the application usage information (master) 311 is specified, which is indicated with data Z. Data Q is information for specifying the remaining storable capacity of the smartphone 200, which moves from the smartphone 200 to the server device 300. In accordance with the information for specifying the remaining storable capacity, a size X of the segment data sets is specified. Further, the data Z is divided into the even segment data sets A, B, and C each having the size X. Among those, the even segment data sets A and B are less than the remaining storable capacity of the smartphone 200, and hence are duplicated through communication to the smartphone 200.

Next, description is given on a buffer acquisition phase of executing the segment information acquisition processing under a state in which the onboard device 100 and the smartphone 200 are connected. In the buffer acquisition phase, a part of the even segment data sets (the even segment data set A) in the smartphone 200 is duplicated to the onboard device 100 through communication. After that, the onboard device 100 issues a deletion request to the smartphone 200, and then the even segment data sets that are normally duplicated are deleted.

Further, description is given on a parallel acquisition phase of executing the segment information acquisition processing under a state in which the onboard device 100 and the smartphone 200 are connected. In the parallel acquisition phase, while the even segment data set B is duplicated through communication from the smartphone 200 to the onboard device 100, the even segment data set C is newly duplicated through communication from the server device 300 because the remaining storable capacity is increased due to deletion of the even segment data set A.

Further, when all the even segment data sets are acquired from the server device 300 by the smartphone 200, the buffer acquisition phase for duplication through communication between the onboard device 100 and the smartphone 200 is started again. In this example, a part of the even segment data sets (the even segment data set C) in the smartphone 200 is duplicated to the onboard device 100 through communication.

When the onboard device 100 acquires all the even segment data, a restoration phase is started, and the onboard device 100 executes processing for integrating the even segment data sets A, B, and C to obtain the data Z corresponding to the application usage information (master) 311. When the restoration is completed normally, the even segment data sets are deleted from the server device 300.

A phase in which the onboard device 100 utilizes the data Z integrated in the restoration phase is referred to as a utilization phase. In the utilization phase, when the data Z is map information, for example, processing for updating existing map data in the onboard device 100 or processing for reading and utilizing the map information is executed. When the data Z itself is a software piece, the data Z is read and executed by the onboard device 100.

The data communication system 1, the onboard device 100, the smartphone 200, and the server device 300 in the embodiment are described above. According to the embodiment described above, the data communication system 1, the onboard device 100, the smartphone 200, and the server device 300 capable of acquiring data smoothly can be implemented even when an amount of data to be acquired is large.

However, the present invention is not limited to the embodiment described above. Various modifications can be made to the embodiment described above within the scope of the technical ideas of the present invention.

For example, in the embodiment described above, the case where the onboard device 100 acquires the application usage information through communication with the server device 300 via the smartphone 200 is exemplified, but the present invention is not limited thereto. For example, the onboard device 100 described in the above-mentioned embodiment may be mounted in a single housing with the smartphone 200.

### REFERENCE SIGNS LIST

1: Data communication system
100: Onboard device
110: Storage unit
111: Application usage information
112: Segment data reception buffer
113: Onboard device profile information
120: Control unit
121: Input control unit
122: Screen control unit
123: Data utilization unit
124: Data integration unit
125: Data acquisition unit
130: Communication unit
140: Touch panel
150: Display
200: Smartphone
210: Storage unit
211: Storage region management information
212: Segment data relay buffer
213: Onboard device profile duplicate information
220: Control unit
221: Control unit linked with external equipment
222: Segment data relay control unit
230: Communication unit
300: Server device
310: Storage unit
311: Application usage information (master)
312: Segment data buffer
320: Control unit
321: Data transmission control unit
322: Segment data generation unit
323: Alteration determination unit
324: Profile management unit
330: Communication unit

1. A server device comprising:
a storage unit configured to store predetermined information to be provided to an external device;
a segment data generation unit configured to receive information for specifying a remaining storable capacity of the external device via communication from the external device and generate a plurality of data sets obtained by dividing the predetermined information substantially evenly in a size depending on the remaining storable capacity; and
a data transmission control unit configured to transmit, to the external device, the plurality of data sets by a number corresponding to the remaining storable capacity.

2. The server device according to claim 1, wherein
when receiving a request from the external device, the data transmission control unit transmits, to the external device, a part of or an entirety of the plurality of data sets that are untransmitted.

3. The server device according to claim 1, wherein
the segment data generation unit generates a plurality of data sets by dividing the predetermined information substantially evenly in a size of a half of the remaining storable capacity or less.

4. The server device according to claim 1, further comprising
an alteration determination unit configured to determine presence or absence of alteration when receiving, from an external device through communication, information for detecting alteration of the plurality of data sets received by the external device.

5. The server device according to claim 1, wherein
the external device is a relay device capable of communicating with an onboard device, and
the relay device transmits the plurality of data sets to the onboard device when receiving the plurality of data sets.

6. The server device according to claim 1, wherein
the data transmission control unit holds the plurality of data sets until receiving an integration completion notification, and deletes the plurality of data sets when receiving the integration completion notification.

7. An onboard device comprising:
a storage unit;
a data acquisition unit configured to receive a plurality of data sets from an external relay device;
a data integration unit configured to integrate the plurality of data sets acquired by the data acquisition unit; and
a data utilization unit configured to utilize the plurality of data sets integrated by the data integration unit to update predetermined data stored in the storage unit.

8. The onboard device according to claim 7, wherein
the data acquisition unit generates information for detecting alteration with regard to the plurality of data sets that are received and transmits the information to the relay device.

9. The onboard device according to claim 7, wherein
the data acquisition unit transmits, to the external relay device, a deletion request for the plurality of data sets that are acquired normally, and the external relay device deletes the plurality of data sets.

10. A data communication method through use of a server device,
the server device including:
a storage unit configured to store predetermined information to be provided to an external device; and
a control unit, the data communication method comprising, executed by the control unit:
a segment data generation step of receiving information for specifying a remaining storable capacity of the external device via communication from the external device and generating a plurality of data sets obtained by dividing the predetermined information substantially evenly in a size depending on the remaining storable capacity; and
a data transmission control step of transmitting, to the external device, the plurality of data sets by a number corresponding to the remaining storable capacity.

11. The data communication method according to claim 10, wherein
in the data transmission control step, when receiving a request from the external device, the control unit transmits, to the external device, a part of or an entirety of the plurality of data sets that are untransmitted.

12. The data communication method according to claim 10, wherein
in the segment data generation step, the control unit generates a plurality of data sets by dividing the predetermined information substantially evenly in a size of a half of the remaining storable capacity or less.

13. The data communication method according to claim 10, wherein
the control unit further executes an alteration determination step of determining presence or absence of alteration when receiving, from an external device through communication, information for detecting alteration of the plurality of data sets received by the external device.

14. The data communication method according to claim 10, wherein
the external device is a relay device capable of communicating with an onboard device, and
the relay device transmits the plurality of data sets to the onboard device when receiving the plurality of data sets.

15. The data communication method according to claim 10, wherein
in the data transmission control step, the control unit holds the plurality of data sets until receiving an integration completion notification, and deletes the plurality of data sets when receiving the integration completion notification.
